(19) United States
(12) Patent Application Publication
(10) Pub. No.: US 2005/0289000 A1
(43) Pub. Date: Dec. 29, 2005

(54) Method for contact stream optimization

(76) Inventors: Eric Chiang, Concord, MA (US); Robert Crites, Mechanicsburg, PA (US); Ruby Kennedy, Bedford, MA (US); Brett Knowlton, Natick, MA (US); Patrick Martin, Lexington, MA (US); Glen Osterhout, Somerville, MA (US); Yuchun Lee, Sudbury, MA (US)

Correspondence Address: FISH & RICHARDSON PC, P.O. BOX 1022, MINNEAPOLIS, MN, 55440-1022, US

(21) Appl. No.: 10/880,419

(22) Filed: Jun. 28, 2004

(51) Int. Cl. G06F 17/00

(52) U.S. Cl. 705/14

(57) ABSTRACT

A method for optimizing transactions to customers from a list of transactions is described. The method includes generating a frequency distribution of scores for each offer based on at least one constraint, determining a score threshold based on the frequency distribution of scores, and adding or removing transactions from the list of transactions based on the score threshold.

### RELATED APPLICATION

This application is also related to patent application Ser. No. 10/015,548, “METHOD FOR CONTACT STREAM OPTIMIZATION”, filed Dec. 11, 2001.

### BACKGROUND

This invention relates to contact stream optimization.

Organizations that desire to conduct a marketing campaign may have multiple contacts with a single customer. For example, an organization can send many different kinds of specialty catalogs to the same customer over a short period of time. Organizations may desire to limit the number of catalogs that are sent to the customer for various reasons. For example, if somebody receives a large number of catalogs from the same organization, they could simply ignore all subsequent mailings from that organization.

Techniques are known to solve what is often referred to as contact optimization. That is, to determine an optimal set of contacts to make with an individual over a period of time given global constraints placed by a marketing organization. One technique uses linear programming. Linear programming solves a system of linear inequalities. The problem is that for a large number of customers and offers the number of variables in these types of optimization problems may run into the millions, which could make a linear programming technique too computationally expensive.

### SUMMARY

In one aspect, the invention is a method for optimizing transactions to customers from a list of transactions. The method includes generating a frequency distribution of scores for each offer based on at least one constraint, determining a score threshold based on the frequency distribution of scores, and adding or removing transactions from the list of transactions based on the score threshold.

In another aspect, the invention is an apparatus for optimizing transactions to customers from a list of transactions. The apparatus includes a memory that stores executable instructions and a processor that executes the instructions to generate a frequency distribution of scores for each offer based on at least one constraint; determine a score threshold based on the frequency distribution of scores; and add or remove transactions from the list of transactions based on the score threshold.

In a still further aspect, the invention is an article comprising a machine-readable medium that stores executable instructions for optimizing transactions to customers from a list of transaction. The instructions cause a machine to generate a frequency distribution of scores for each offer based on at least one constraint; to determine a score threshold based on the frequency distribution of scores; and to add or remove transactions from the list of transactions based on the score threshold.

One or more of the following features may be provided in the aspects. The at least one constraint may be one of a budget constraint, an offer constraint and a capacity constraint. The aspect may also include generating a budget frequency distribution based on a budget ratio; determining a budget threshold based on the budget frequency distribution; and adding or removing transactions from the list of transactions based on the budget threshold. The budget ratio may include a cost and a score. The aspect may include modifying the frequency distribution of scores based on interactions between transactions. The scores may include a profitability value.

The aspect may include rendering a tool that includes a sensitivity analysis. The tool may includes a graph. The tool may include a table. The tool may include a graphical user interface and the graphical user interface may allows a user to change parameters to determine an impact on optimization.

In other aspects, the invention is a computer program product resides on a computer readable medium. The product determines a prioritized number of communications (e.g., offers) to use to contact customers from a group of customers. The product comprises instructions to cause a computer to determine an ordered set of offers to be sent to each customer. For each customer, the product eliminates offers that violate any specified rules and/or constraints. For example, any offers that are riot applicable to the customer based on eligibility rules for the offers, offers that might conflict with previous communications, offers that might exceed specified contact fatigue limits (e.g., a maximum number of offers over a specific time period, or using a particular channel, or of a certain offer type), or offers for which an expected profit for the customer is below a threshold amount. In addition, the product optimizes across customers for capacity-based constraints, such as a minimum or maximum budget, number of a particular offer, or channel bandwidth over a period of time. The remaining offers are ordered by a score representing the objective function (e.g., minimizing or maximizing a metric such as expected profit, revenue, probability of response, brand awareness, loyalty, etc.).

In other aspects, the invention is system for determining a prioritized number of offers to send to customers from a group of customers includes a computer and a computer-readable medium storing a computer program product. The computer program product includes instructions for determining the prioritized number of offers and determining an ordered set of offers to be sent to each customer. For each customer, the product eliminates any offers that violate any specified rules and/or constraints. In addition, the product optimizes across customers for capacity-based constraints. The product orders remaining offers using the specified objective function.

### BRIEF DESCRIPTION OF THE DRAWINGS

FIG. 1 is a block diagram of a computer system executing direct marketing and/or data mining software, including contact optimization software.

FIG. 2A is a block diagram of a table of records.

FIG. 2B is a diagram of a record.

FIG. 3 is a flow chart that depicts components of contact optimization.

FIG. 4 is a flow chart of the core contact optimization process.

FIG. 5 is a flow chart of an alternative generation process.

FIG. 6 is a flow chart of a budget process.

FIG. 7 is a flow chart of a contact optimization process when there are limits on the number of customers per offer.

FIG. 8 is a flow chart of a contact optimization process used to assign offers to customers that were truncated.

FIG. 9 is a flow chart of a contact optimization process used when operating with minimum capacity constraints on offers.

FIG. 10 is a flow chart of contact optimization when operating multiple constraints.

FIG. 11 is a flow chart for generating frequency distributions.

FIG. 12 is a flow chart for optimization using frequency distributions.

FIG. 13 is a flow chart of a modified univariate scoring approach.

FIG. 14 is a sensitivity analysis chart.

FIG. 15 is a graph of the chart in FIG. 13.

### DETAILED DESCRIPTION

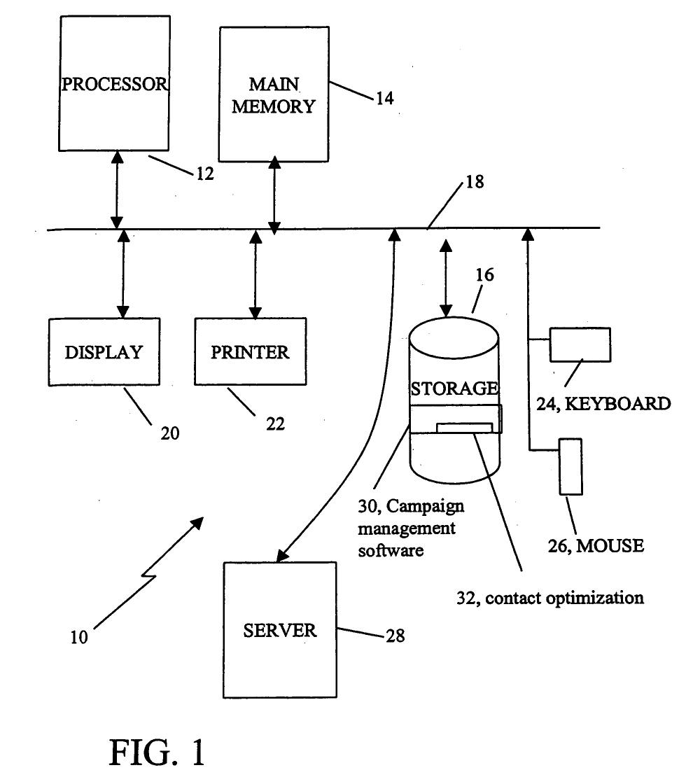

Referring now to FIG. 1, a computer system 10 includes a CPU 12, main memory 14 and persistent storage device 16 all coupled via a computer bus 18. The system 10 also includes output devices such as a display 20 and a printer 22, as well as user-input devices such as a keyboard 24 and a mouse 26. Not shown in FIG. 1 but necessarily included in a system of FIG. 1 are software drivers and hardware interfaces to couple all the aforementioned elements to the CPU 12.

The computer system 10 also includes automated campaign management software 30 that includes contact optimization software 32 that prioritizes offers sent to multiple contacts based on given criteria. The contact optimization software 32 provides a streamlined technique that should execute faster than linear programming solutions, and which can find an optimal solution if there are no capacity limits (e.g., on the number of customers per offer, number of offers that can be sent on a given channel, or budget/resource constraints), and can find a nearly optimal solution otherwise.

The contact optimization software 32 considers each customer independently, and supports eligibility constraints as well as rules of the form (M,S), i.e., “only M offers from set S are allowed”. These “M of S” type constraints can be used to support mutually exclusive offers, as well as channel, customer segment, and other constraints. The contact optimization software 32 also supports an overall budget.

The automated campaign management software 30 and contact optimization software 32 may reside on the computer system 10, as shown, or may reside on a server 28 that is coupled to the computer system 10 in a conventional client-server arrangement. The details on how this automated campaign management software 30 and contact optimization software 32 is coupled to this computer system 10 are not important to understand the present invention.

Generally, data mining software (not shown) executes complex data modeling algorithms such as linear regression, logistic regression, back propagation neural network, Classification and Regression Trees (CART) and Chi-squared Automatic Interaction Detection (CHAID) decision trees, as well as other types of algorithms that operate on a data set. Also, the data mining software can use any one of these algorithms with different modeling parameters to produce different results. The data mining software can render a visual representation of the results on the display 20 or printer 22 to provide a decision maker or the automated campaign management software 30 with the results. The results that are returned can be based on different algorithm types or different sets of parameters used with the same algorithm. The results can be returned with or without a visual depiction of the results such as a score itself, calculating a root mean square value (RMS) value, and so forth. One approach is to render a graph or other visual depiction of the results. Part of the results returned could include a predicted or expected profit that can result from sending a particular offer to a particular customer or potential customer or contact. A score is a metric provided by a user of system 10 to indicate the relative value a proposed customer/prospect/household or other marketable entity contact has in a particular category of importance to the user. For example, a category may include profitability of contacting the customer, expected revenue of contacting a customer, probability of success at approaching the customer, brand awareness, customer loyalty, and so forth. In other examples, the higher the score assigned by the user, the higher the user rates a customer in the particular category. While predictive models represent one way in which scores can be generated, scores also can be assigned by other methods (e.g., rules, manually, etc.).

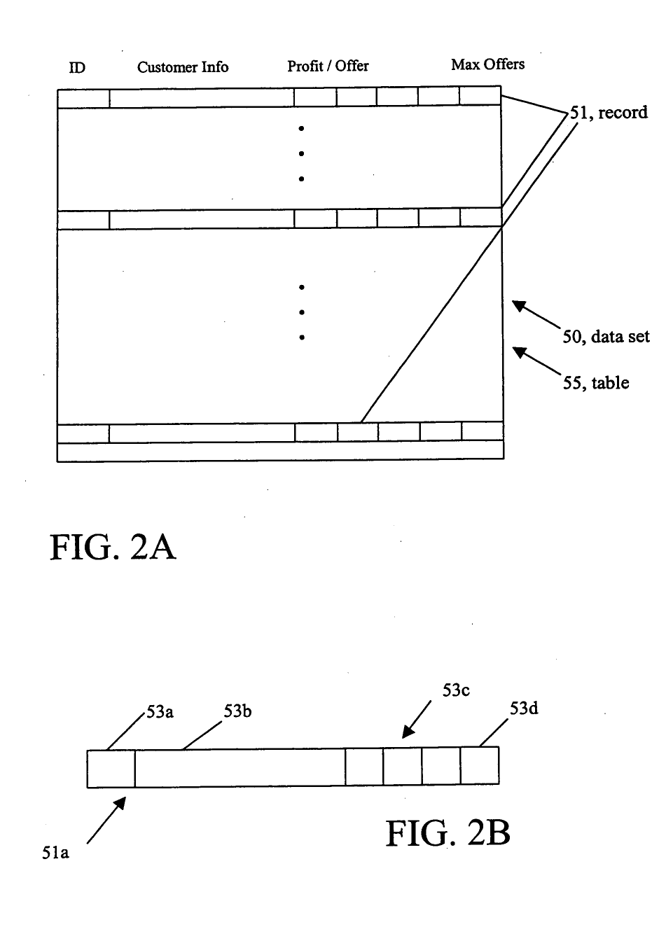

Referring now to FIGS. 2A and 2B, a data set 50 includes a plurality of records 51. A customer is represented by a record 51. The records 51 are organized into a table 55. The customer data inputs are stored in the records 51. The records 51 (FIG. 2A) include an identifier field 53a and a plurality of fields 53b containing customer information that may be needed for determining each customer's eligibility to receive each offer, for computing the expected profit from sending each customer each offer, for rule resolution, customer segmentation, analysis, or other functions. The records 51 also include fields 53c for expected profit corresponding to offers that are used in the contact optimization process 32, which could have been previously computed. In the table 55, each record 51 represents a customer in rows of the table and each column represents information about the customers such as identifiers, eligibility information, expected profits from the offers, the maximum number of offers per customer, and so forth.

The score used for optimization (e.g., expected profit) could be determined by modeling characteristics of the customer using one of many different types of algorithms, as mentioned above, or any other number of methods. The expected profit could be the output from a model or some formulas for computing the expected profit. For example, a model might predict the response rate that is multiplied by the expected revenue from that particular offer. To determine the expected profit, the cost of sending that offer is subtracted from revenue.

Another field 53d in the record 51 and entry in the table 55 is the maximum number of offers that can be sent to each customer. The maximum number of offers field 53d can be represented as a vector (as shown), or as a scalar, i.e., a string of maximums for the customers or a single maximum number for all customers.

“Constraints” have many possible “answers” where the “best” answer is selected by maximizing an objective function. For example, a constraint may specify that each individual can receive a maximum of three offers. If a particular individual is eligible to receive 20 possible offers, there are (20 choose 3) possible answer sets. The best set is the one that maximizes (or minimizes) the scores associated with each possible offer. Constraints are imposed by a marketing organization and are processed in the contact optimization software 32. “Rules”, on the other hand, have a single answer and can be resolved without scores or an objective function. For example, a rule might specify that offer A cannot be sent within 30 days of offer B, or that people with credit scores<X are not eligible to receive offer Y. There are a variety of different types of rules and constraints that are supported by the contact optimization process. There are many different kinds of constraints and rules that a user can generate (not limited to the following):
(1) “Eligibility constraints” or “global suppressions” are examples of rules that are applied with respect to each current offer and considered independently. The rules are represented by expressions having arithmetic, relational, logical, and/or other operators acting upon customer input data. An example is a customer meeting a minimum salary or age requirement.
(2) Offer conflict rules specify that certain offers cannot be received together within some time period, or that one (or a set of) offer(s) cannot follow another offer (or set of offers). For example, if a customer received offer X within the past 3 months (according to the customer input data), then they are not currently eligible to be sent offer Y.
(3) “Limits on the number of offers per customer” or contact fatigue constraints. This is a type of constraint where each customer is limited to receive no more than some maximum number of offers. The limit may vary among the customers. The limits also may be based on customer segments, channels, offer sets as well as time. For example, a constraint might specify that customers that have never before responded to an email offer cannot receive more than 3 loan-type offers using the email channel per month.
(4) “(M,S) constraints”. These are constraints where no more than M offers from set S of offers may be sent to any customer. These constraints are applied with respect to combinations of current offers and are not based on customer input data. Channel constraints are a particularly useful capability provided by (M,S) constraints, e.g., if at most one offer can be sent via email, and offers 3, 4, and 6 are email offers, this constraint can be enforced as the following (M,S) constraint: (1, {3,4,6}). Mutually exclusive offers can also be accommodated using (M,S) constraints.
(5) “Overall budget constraints”. These constraints are governed by overall marketing costs. These constraints can be applied when marketing costs need to be limited by some minimum or maximum amount. Similarly, budgets can be specified for particular customer segments, marketing campaigns, offers, channels, etc., or combinations thereof.
(6) “Maximum capacity constraints”. These constraints express limits on the number of customers per offer or the number of customers per channel, possibly due to limitations in the supply of either products or marketing materials or the limited bandwidth or throughput of various channels (e.g., a call center may have sufficient staff to handle 10 k outbound calls per week).
(7) “Minimum capacity constraints”. These constraints are applied where some minimum number of a particular offer is to be sent out or some minimum number of contacts must be made using a particular channel, regardless of profit. For example, this might be used if a fixed amount of marketing materials have already been purchased or a call center already is already paying for telemarketers, and it is desired that they not be wasted.
(8) “Minimum number of unique offers” or “Maximum number of duplicate offers”. These constraints specify that a particular individual (or customer segment) must receive a minimum number of different offers over some time period (e.g., to make sure that all parts of the customer base minimally receive some contact in the course of a year) or limit the maximum number of times they can receive the same offer.

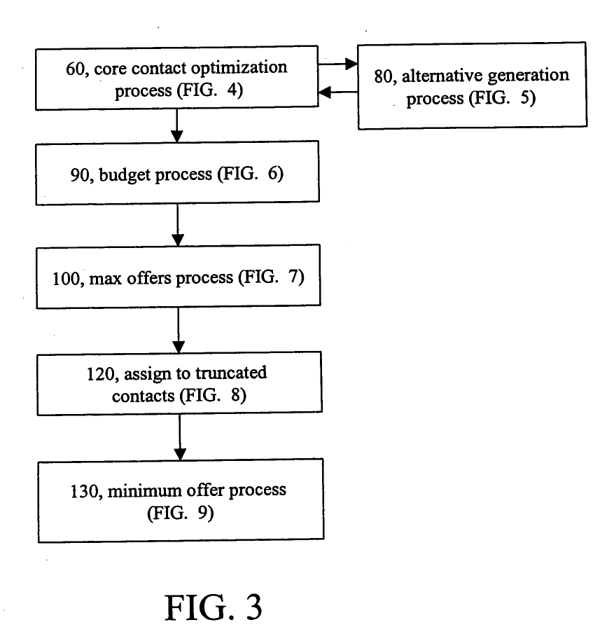

Referring to FIG. 3, contact optimization software 32 executes a core contact optimization process 60 that selects an optimal set of offers to send to each customer. By optimal is meant that the offers to send are selected to maximize the specified objective function/scores (e.g., profit) and possibly stay within a budget, while satisfying any given constraints and not violating any rules. For example, it might actually be more profitable to make four contacts with a particular customer. But, the maximum contacts allowed for the customer may be three contacts due to budget or other constraints. Within the constraints given the contact optimization process selects the most profitable combination of offers for each customer. The contact optimization process proceeds on a customer-by-customer basis.

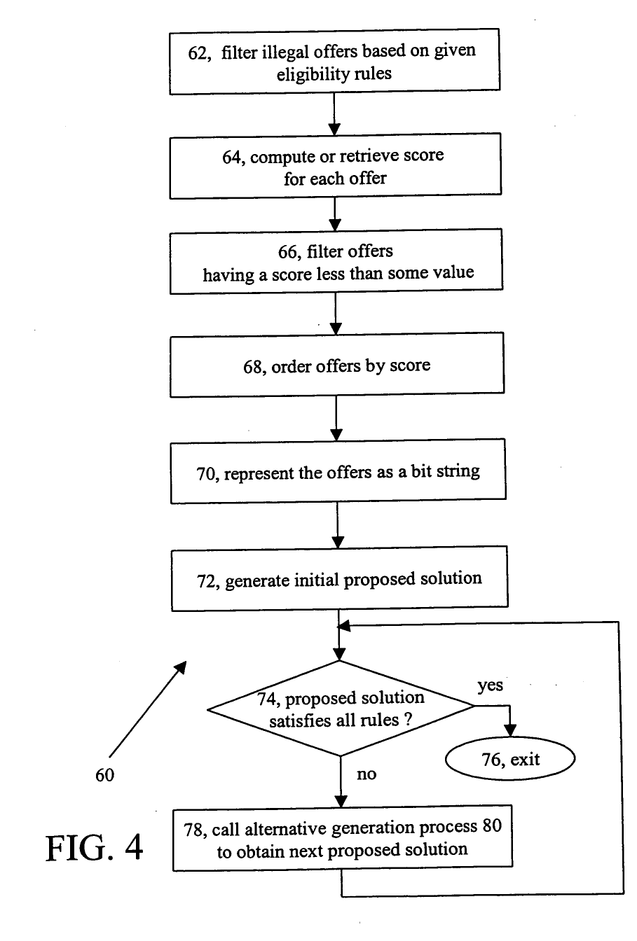

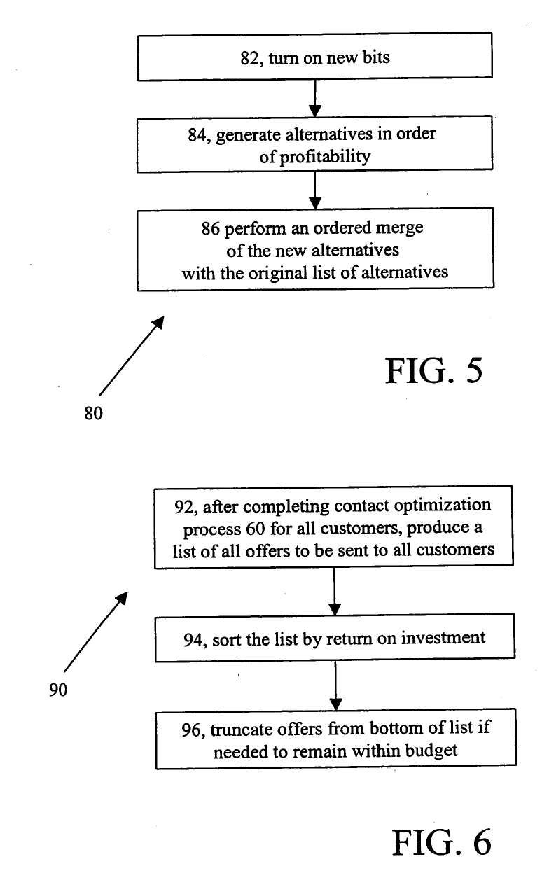

This process 60 is run for each customer individually. An example of the core contact optimization process 60 is set out in FIG. 4 below. As will be described in FIG. 4, the core contact optimization process 60 for each customer, filters out invalid offer combinations and orders remaining offers by the offer score (e.g., expected profit). The process 60 represents remaining offers as a bit string and generates an initial proposed solution that is checked against all (M,S) type constraints. If all rules and constraints are satisfied, the proposed solution is accepted for the customer and the process 60 evaluates the next customer. The contact optimization software 32 executes an alternative generation process 80 as set out in FIG. 5 whenever constraints of the type (M,S) are violated by a proposed solution for a given customer.

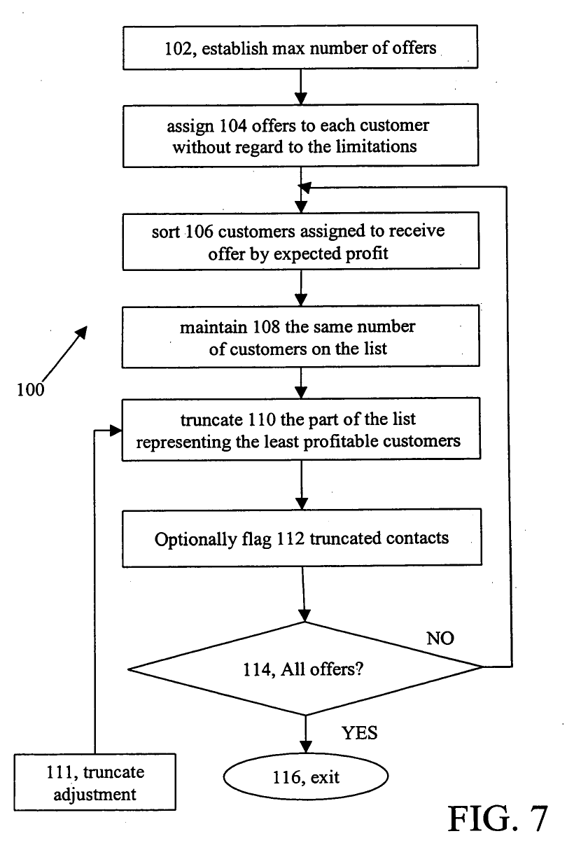

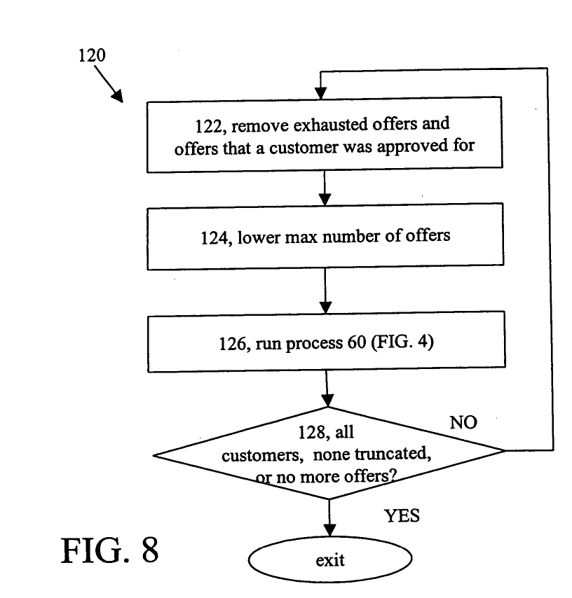

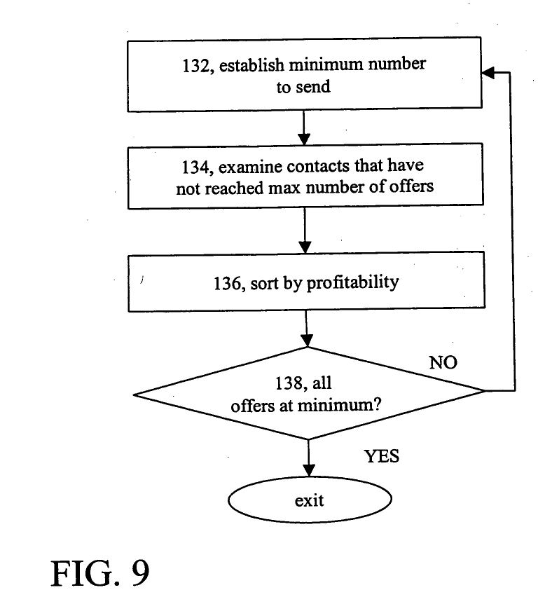

After all customers have been evaluated, the contact optimization software 32 executes a budget process 90 as described in FIG. 6. The contact optimization software 32 can include a process 100 to assign offers to customers based on constraints that impose a maximum amount of any given offer, as in FIG. 7. The contact optimization software 32 can include a process 120 as in FIG. 8 to reassign offers to customers that were truncated by the process of FIG. 7. The contact optimization software 32 can also include a process 130 to evaluate rules dealing with minimum capacity of offers as in FIG. 9.

Referring to FIG. 4, an example of the contact optimization process is shown. For each particular customer, the core contact optimization process 60 filters 62 out any illegal offers based on given eligibility type/suppression rules as discussed above. One example was given above whether the current customer has a specified income level or age to receive the present offer and so forth. The core contact optimization process 60 computes 64 the score (e.g., expected profit) for each offer for that particular customer unless it is provided, in which case the score can be retrieved. Optionally, if the objective function is to maximize scores, the core contact optimization process 60 filters 66 out any offers that have a score less than or equal to zero or some other value. If the objective function is to minimize scores, offers with a score greater than or equal to some value can be eliminated. The core contact optimization process 60 orders 68 the remaining offers by their score (e.g., expected profitability).

The core contact optimization process 60 represents 70 the offers as a bit string. The length of the bit string is the total number of offers that are still valid for the customer after all of the filtering processes discussed above. The length of the bit string is the number of zeros and ones in the string with each bit representing one of the offers. The bits are ordered by the score (e.g., expected profit). Illustratively, assume that the left most bit is the most “profitable” offer and the right most the least “profitable.” A “one” indicates send the offer to that customer and a “zero” indicates do not send the offer.

The core contact optimization process 60 starts by generating 72 the most profitable bit string as the initial proposed solution. The initial proposed solution is generated in a way that obeys any limit on the number of offers for the customer. For example, if “N” is the maximum number of offers for the customer, the initial proposed solution will be the string that has the first N bits as ones and bits thereafter as zeros. For example, if N=4 with 10 possible offers, the initial proposed solution will be (1111000000).

The core contact optimization process 60 will test 74 to see if the proposed solution violates any rules or constraints of the “(M,S)” type. If that string does not violate any rules or (M,S) type constraints, then that is the answer and the process exits 76. Otherwise, the core contact optimization process 60 will generate 78 the next most profitable alternative string as a proposed solution, which will be tested 74. The core contact optimization process 60 will continue to generate and test alternative solutions in this manner until the best solution (from a customer-centric perspective) is found that does not violate any rules or constraints.

When testing proposed solutions against (M,S) type constraints, the core contact optimization process 60 can achieve greater computational efficiency by ordering the (M,S) constraints in an intelligent way. For example, the process 60 can give priority to testing constraints that have the lowest values M and the largest sets S, because evaluation of those rules against potential sets of offers most quickly tend to restrict the space of possible solutions.

Referring to FIG. 5, if the current solution being evaluated violates some rule or constraint, the core contact optimization process 60 calls 78 an alternative generation process 80 that generates one or more alternative solutions. The alternative generation process 80 turns on 82 new bits that will be on in all of the alternative solutions generated. The alternative generation process 80 generates 84 alternative solutions to maximize the objective function (e.g., in order of profitability), and performs 86 an ordered merge of the new alternatives with the original list of alternatives. The merge 86 essentially interleaves the alternatives with the original list as appropriate to retain the overall profitability order. That is, the alternative generation process 80 generates new alternatives in the order of profitability and merges them into an alternative list retaining the profitability order.

For example, the current list contains three alternative solutions with profitability scores of “100”, “50”, and “25”. The alternative generation process 80 generates two additional alternative solutions with profitability “150” and “75”. By merging 86, the alternative generation process 80 retains the profitability order of the alternative solutions producing a new list ordered as “150”, “100”, “75”, “50”, and “25”.

Referring back to FIG. 4, the alternative solution with the highest profitability “150” is the next proposed solution to be tested 74 to see if all rules and constraints are satisfied.

Details of the actions of the alternative generation process 80 are set out below. The alternative generation process produces a set of new alternatives when a constraint of the (M,S) type, i.e., “only M offers from set S are allowed” is violated. If such a constraint is violated, some number of bits T greater than M bits from the set S were on. Call the rightmost one bit in the string, R1. The new alternative generation process turns on 82 (T−M) new bits that are not a part of set S changing the new offers from a zero bit to a one bit. The bits representing these offers immediately follow R1 until no more bits are left.

For example, the string (1111000000) represents sending the 4 most profitable out of 10 possible offers. In this example, the string violates a rule that says “only one of the first two offers” is allowed. That means that the first two offers are mutually exclusive. In this example, the rightmost one bit is the fourth bit hence R1 is four.

The alternative generation process 80 will turn on 82 (T−M) new bits. In this case M is “one”, because only one offer out of the offers from set S that contains offer one and offer two, is allowed. In the example string, (1111000000), a number T of those bits from set S are on (T is 2). Since the number T is greater than M (M is 1), the process turns on T−M new bits (2−1=1), i.e., one bit. That bit is not a part of set S and immediately follows bit R1 (bit 4). Let the rightmost new bit be called R2 (in this example R2=bit 5). The process 80 generates new alternatives based on all M bit combinations of the T bits up to R1 and any 0 bits in set S between R1 and R2. In the example, the alternative generation process 80 turns on bit number 5 because that bit immediately follows bit R1 and is not a part of set S.

If the alternative generation process 80 reaches the end of the string and there are no possible bits representing offers that the alternative generation process 80 could turn on, (case not shown) then the alternative generation process 80 does not turn on any more bits. In some cases, the alternative generation process 80 may need to turn on multiple bits.

After the alternative generation process 80 turns on a new bit, the alternative generation process 80 generates 84 an alternative list based on all bit combinations of the T 1 bits up to R1, and any zero bits in set S between R1 and R2. In this case, the T 1 bits (T is 2) are the first two bits. The alternative generation process 80 tries all possible combinations. All M bit combinations (for M=1) are tested, i.e., all the combinations where only one of the first two bits is turned on, either (10) or (01). In this case, there are two combinations that can be generated. The process 80 can use a mathematical function for the number of combinations of T elements taken M at a time
C(T,M)=T!/(M!*(T−M)!)

to determine how many different alternatives will be generated, e.g., C(2,1)=2.

The alternative generation process 80 generates these alternatives in order of profitability. In this case, with only two alternatives, the (10) alternative has to be better than the (01) alternative because the process has ranked the offers by profitability.

But, in cases where multiple bits are turned on the combinations often need to be further examined. For example, where 2 out of 4 bits can be turned on, there are 6 combinations and the alternative generation process 80 generates 84 the combinations (1100), (1010), (1001), (0110), (0101), and (0011). All of the combinations are generated in order with the possible exception of the (1001) and (0110) combinations. The combinations are generated in order when more profitable bits are only swapped with less profitable bits. The combinations are not necessarily generated in order when both more and less profitable bits are swapped to generate a new combination as in the (1001) and (0110) combinations.

In that case, the process 84 performs a comparison. In the example, the process 84 compares the sum of the profitability of the first offer and the fourth offer to the sum of the profitability of the second offer and the third offer. Even though the individual offers are already ranked the process performs the additional comparisons to maximize the total profitability of the set of offers.

A recurrence relation for the number of additional comparisons needed is set out below:

Comp(a 1)=0

Comp(a a-1)=0

Comp(a b)=Comp(a-1 b-1)+Comp(a-1 b)+1

(where 1<b<a-1)

In the example above with 2 out of 4 bits to turn on, a=4 and b=2, so one additional comparison is needed:

$$\begin{matrix}Comp ( \begin{matrix}4 & 2\end{matrix} ) = Comp ( \begin{matrix}3 & 1\end{matrix} ) + Comp ( \begin{matrix}3 & 2\end{matrix} ) + 1 \\ = 0 + 0 + 1 \\ = 1\end{matrix}$$

Some examples of generating new alternatives:

### EXAMPLE 1

If ordered bit string of offers (1111000000) violates a rule (1, {1,2}), which means that offers 1 and 2 are mutually exclusive, the sorted alternatives generated would be:
(1011100000) and (0111100000).

If ordered bit string (1011100000) then violates another rule (2, {3,4,5,7}), meaning that only 2 offers from the group of offers 3, 4, 5 and 7 can be sent, the sorted alternatives generated would be:
(1011010000), (1010110000), and (1001110000),

which would be merged with the already sorted list containing (0111100000).

However, if the ordered bit string (1011100000) violated another rule (2, {3,4,5,6}), the alternatives generated would be:
(1011001000), (1010101000), (1010011000), (1001101000), (1001011000), and (1000111000).

If the ordered bit string (0010001100) violated another rule (2, {3,4,6,7,8,10}), the sorted alternatives generated would be:
(0010001010), (0010000110), and (0000001110).

Referring to FIG. 6, the contact optimization software 32 can accommodate an overall budget constraint or multiple budget constraints based on offers, channels, or customer segments, as discussed above. In that case, after the core contact optimization process 60 has determined the optimal set of offers for all potential customers, the budget process 90 produces 92 a corresponding single list of all of the offers to send to all of the customers. The budget process 90 sorts 94 that list by the value of “score” divided by “cost” (e.g., when the “score” is profit and the “cost” is the marketing expense of sending the offer, this is equivalent to the return on investment (ROI)) such that a user can send out as many offers as fit within the limited (monetary) resource or budget. Any remaining offers that do not fit within the budget are truncated 96 off the bottom of the list of offers.

Many users could operate the contact optimization software 32 with a maximum budget to spend on contacting customers during marketing campaigns. This contact optimization software 32 partly prioritizes based on constraints to minimize contacts with customers to avoid annoying the customers with excessive contacts in addition to supporting capacity constraints (on offers or channels) and/or an overall or finer-grained budgetary constraints. The contact optimization software 32 allows a user to deal with all of these types of constraints at the same time and in the most valuable/profitable way.

Referring to FIG. 7, when there are capacity constraints (e.g., limits on the number of customers per offer or per channel), the software 32 offers a near optimal solution 100. For example, a user can only send 102 out a limited number of offers, e.g., 10,000 of a particular offer. That is a case where linear programming, given sufficient time and computational power could provide an optimal solution. In the contact optimization software 32 a close-to-optimal solution that is inexpensively obtained is provided. The software 32 assigns 104 offers to each customer without regard to the limitations on the quantity of each offer, using the core contact optimization process 60. For each offer, the software 32 sorts 106 the customers assigned to receive that offer by expected profit.

For the number of available units, the software 32 keeps 108 the same number of customers on the list. The software truncates 110 the part of the list representing the least profitable customers to get that offer. The software 32 can flag 112 those contacts, which are truncated. The software 32 repeats 114 this for all offers for all customers and can thereafter exit 116.

Referring to FIG. 8, the software 32 can run a process 120 to assign offers to customers that were truncated. The process 120 operates on the customers that were flagged as having been truncated. The software 32 removes 122 any offers that are already exhausted where all contacts for the particular offer have already been chosen. Exhausted offers are not included in the next round of optimization. The software 32 also does not consider any offers that the truncated customers were already approved for. The software 32 also accordingly lowers 124 the maximum number of offers to send to the customer by the number of offers already approved for the customer. The process 60 is repeated 126 so the truncated customers have an opportunity to have other offers assigned to them, to make up for any offers that were taken away from them. This process is iterative and is repeated as necessary until no more customers have been truncated. The software 32 offers a near optimal solution with minimal computation compared to linear programming.

Referring back to FIG. 6, alternatively, truncating rather than occurring at the boundary of the exhaustion of the number of offers, e.g., at the 10,000 units of the offer, the software 32 could allow a user to adjust 111 or manipulate where to truncate. Thus, instead of truncating at 10,000 the user may truncate at 7,000 or 5,000 units of the offer and then run the process 60 again. In that way customers who would have been truncated may still have a second opportunity to receive a unit of the offer.

Another alternative examines the individual variance on the profitability of the offers for each customer. For a particular customer the expected profits may be about the same for all of the offers. That is, for some low variance customers it would not matter much which offer is sent (i.e., the opportunity cost of not giving them their highest ranked offer is low). Another type of customer may have a large variance, so which offer is sent could provide a significant difference in profit (i.e., the opportunity cost of not giving them their highest ranked offer is high).

The software 32 could take the offer away from the customer with the low variance first because it matters less which offer is sent to that customer. It could be given to the customer with the high variance. The software 32 can compute the variance across the offers (for offers that have a capacity constraint) for each customer and use the computed variance to rank which customers should be removed from receiving a particular offer.

Another feature of the software 32 when operating with limited capacity, is to have a report indicating how much profit the limited capacity costs the user.

Referring to FIG. 9, another related matter is dealing with a “minimum capacity” constraint as discussed above. With a minimum capacity constraint, a user wants 132 to send out at least a certain number of offers, irrespective of profit. Such minimum capacity constraints are addressed after the optimization process 60 has made its assignments for all the customers. The software 32 would examine 134 those people that had not reached the maximum number of offers they are allowed to receive, and sort 136 them by profitability for any offers that have not reached the specified minimum capacity. The process can run 138 until all offers have reached minimum capacity.

The software 32 can include special support for what-if scenarios (i.e., store runs and make comparisons among them). The software can also generate reports. One report is a cross-tab report that shows the number of people that originally qualified for a communication that were “removed” by another higher priority campaign.

The process 60 assumes that the expected profit of each offer is not affected by other offers that may be sent. However, it is possible to circumvent this assumption by presenting the system with all combinations of offers. Thus, for example, if there are offers A and B whose expected profit depends on whether they are sent alone or together, the system could instead be presented with three offers: X (corresponding to A alone), Y (offers corresponding to B alone), and Z (offers corresponding to both offers A and offers B). A mutual exclusion (M,S) constraint can be used to make these new offers mutually exclusive: (1, {X, Y, Z}). (M,S) constraint can also be used to make those combinations of offers mutually exclusive that would lower expected profits of the combination of offers.

In other examples of optimization, a random selection process may be used to comply with a capacity rule that specifies either maximum capacity constraints or minimum capacity constraints on offer transactions (herein after also referred to as just “transactions”). A transaction is the intersection of an offer, individual, channel, and date. Each proposed offer is a transaction, because it's proposed to a particular person on a particular channel on a particular date.

For example, if the number of proposed offer transactions, e.g., transactions exceeds a specified maximum (contact-fatigue constraint), some transactions are removed (“forced-out”) from the list of proposed offer transactions in order to comply with the maximum capacity constraint. Likewise, if the number of transactions is below the transaction minimum, some orders are added-in (“forced-in”) to comply with the minimum capacity constraint. Using the random selection process, the “force-in” or “force-out” operations are randomly based on the proportion of remaining transactions needed by the capacity rule to the total number of remaining transactions. For example, if there is a maximum capacity rule limiting the number of transactions to 200 transactions, but there are 400 transactions to be evaluated, then the next one of these transactions would be “forced-out” with a probability 200/400=0.5

An advantage of the random selection process is that the process may avoid a large number of “forcing” operations where removing or adding-in transactions is not necessary (e.g., the maximum number of transactions allowed is approximately equal to the total transactions to be evaluated; or minimum number of transactions allowed is much less than the total transactions to be evaluated).

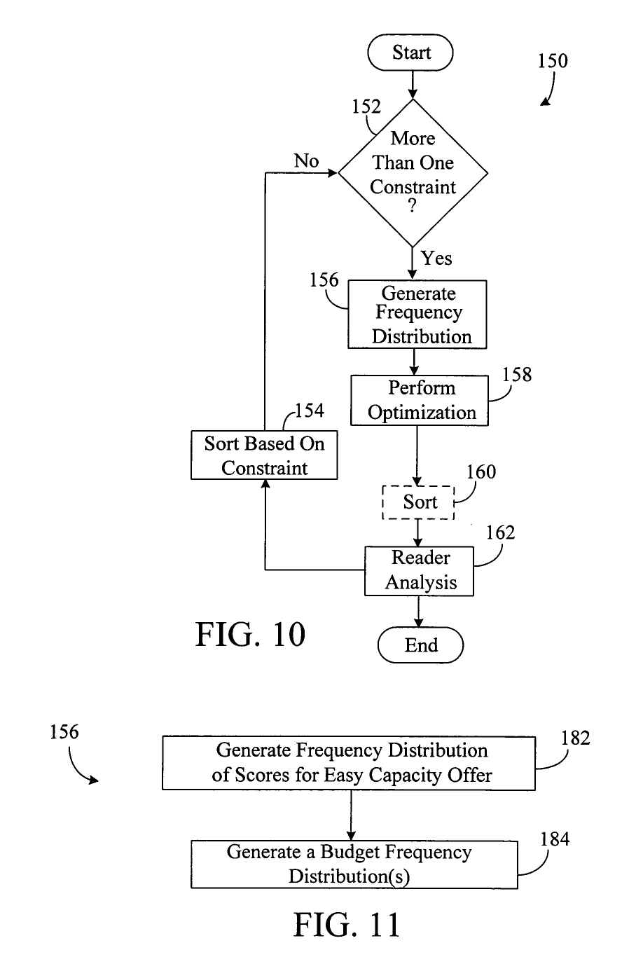

Referring to FIG. 10, an alternative optimization process 150, as for instance in the contact optimization process 32, is shown. Process 150 determines (152) if there is more than one constraint used during the optimization. A constraint may be a minimum offer constraint (e.g., no less than 5,000 offers may be made on product X), a maximum offer constraint (e.g., no more than 10,000 offers may be made on product Y), a minimum or maximum channel capacity constraint (e.g., at least 5,000 and no more than 10,000 calls to customers may be placed by a call center), or budget constraint(s) (e.g., total spending is limited to $1 million and no more than $100,000 can be spent on offer X or campaign Y) for instance. If only one constraint is required for optimization, then process 150 can sort (154) transactions based on the constraint.

However, if more than one constraint is used, then process 150 generates (156) frequency distributions of scores in a first pass through the transactions, and in a second pass through the transactions performs (158) an optimization based on the frequency distributions of the scores generated in the first pass.

Referring to FIG. 11, a process 156 generates (182) a frequency distribution of scores for each offer, channel, or resource (e.g., budget) with a capacity constraint. For example, scores are required for each offer transaction, which could be provided as field 53c in table 55 of FIG. 2, or could be provided by rules (e.g., score assignment based on a customer segment and offers cross-tab). Scores for the offer are retrieved (e.g., from the proposed transactions) and a frequency distribution is built using these scores.

Process 156 generates (182 and 184) frequency distributions for each capacity offer (channel, offer, budget) over all proposed transactions. For example, a budget frequency distribution is generated based on a budget ratio, b, where the numerator of the budget ratio is the score and the denominator of the budget ratio is the cost associated with each transaction. The budget frequency distribution tracks a frequency of the budget ratio and the corresponding cost and is used to determine a budget threshold in the second pass (158).

In other examples, the budget frequency distribution may be computed in two separate budget frequency distributions. A first budget frequency distribution tracks the frequency of the budget ratio and is used to determine the budget threshold used to intelligently determine optimality of giving a particular offer to a particular individual in a one-pass solution (i.e., one additional pass after the frequency distributions are generated).

Simultaneously a second budget frequency distribution is generated to include the frequency distribution of the corresponding cost. A budget threshold is calculated from this frequency distribution based on the available budget.

By accumulating, the costs associated with the transactions, rather than simply counting the number of transactions, a single budget distribution can be produced that includes the information needed by the process 150. To reconstruct the scores, the costs c can be multiplied by the budget ratio b, since b*c=(s/c)*c=s.

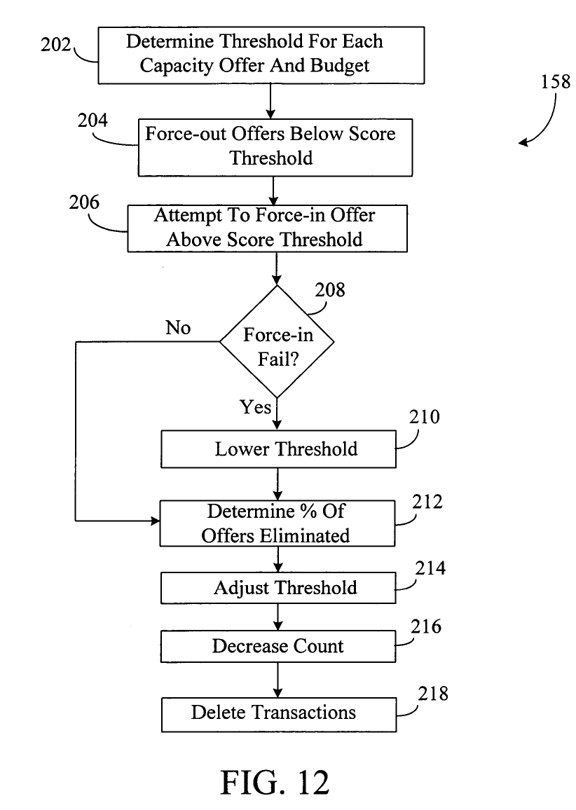

Referring to FIG. 12, the optimization 158 used in the process 150 includes using the frequency distributions to determine (202) a score threshold for each capacity constraint and for any budget constraints. During the processing for each customer, process 158 forces-out (204) offers below the scoring threshold. Process 158 attempts (206) to force-in any capacity offers above the scoring threshold. An attempt can fail because other rules/constraints may be violated. Process 158 determines (208) if the attempt to force-in offers was rejected. If the attempt to force-in offers was rejected (due to violation of some other rule or constraint), process 158 lowers (210) the scoring threshold to compensate for the failure.

Process 158 also determines (212) a percentage of offers that have been eliminated based on other rules such as offer conflict resolution rules. Process 158 adjusts (214) the scoring threshold to a lower value to “buffer” and to anticipate the same rate of interaction contention moving forward, i.e., an ongoing extrapolation projecting forward the number of previously seen conflicts so that the threshold value is as accurate as possible. Process 158 decreases (216) a count (or a cost) in the frequency distribution for each score, as the score is processed, and deletes (218) those transactions from further consideration for that customer.

Using frequency distributions to determine score thresholds may be implemented in a number of ways. For example, one approach is a “univariate score” approach, where frequency distributions of scores are generated (156) for the transactions covered by each minimum/maximum capacity rule, during a first pass. The frequency distributions are used to determine (202) a score threshold for “forcing-in” or “forcing-out” transactions. For example, consider the scenario where a user wants 200 out of 400 transactions and the frequency distribution is:

| Score | Transactions |
|---|---|
| 80-99 | 150 |
| 60-79 | 50 |
| 40-59 | 100 |
| 20-39 | 100 |

The threshold would be set to a score of 60, because there are 150 transactions from 80-90 and 50 transactions from 60-79 for a combined number of transactions of 200. Any transactions with scores above 60 would be initially forced-in.

In some cases, not all 200 transactions with scores above 60 may be used. For example, if two offers, offer A and offer B, with maximum capacity rules were both expecting to receive a transaction for a particular customer, but there was an rule “IF an offer A then NOT offer B” that would not allow offer A and offer B to be offered to the particular customer, the threshold may be adjusted dynamically. That is, if a transaction with a score of 80 was rejected then the threshold might be changed from 60 down to 59, for instance. However, if a transaction with a score of 59 may have been passed earlier and had been rejected, then a transaction with a score of 58 may be accepted, even though the transaction with a score of 59 would be a better choice. Thus, do to the nature of a single optimization pass, a buffer can be used with the score threshold to initially allow the scores of 58 or 59 to be accepted, anticipating some potential conflicts later on, if offer conflict rule(s) exist concerning the offer with the capacity constraint.

The univariate scores approach does not account for the scores of interacting offers. For example, offers can interact to the detriment of maximizing a category. That is process 158 could “force in” a transaction with a score of 40. However, if due to a minimum capacity rule on offer A, that forcing-in of the transaction with the score of 40 would prevent that customer from getting offer B, which would be worth more, e.g., 500 it would be an undesirable situation since the process did not maximize a particular category. Therefore, another approach is to use “univariate scores with interactions” approach.

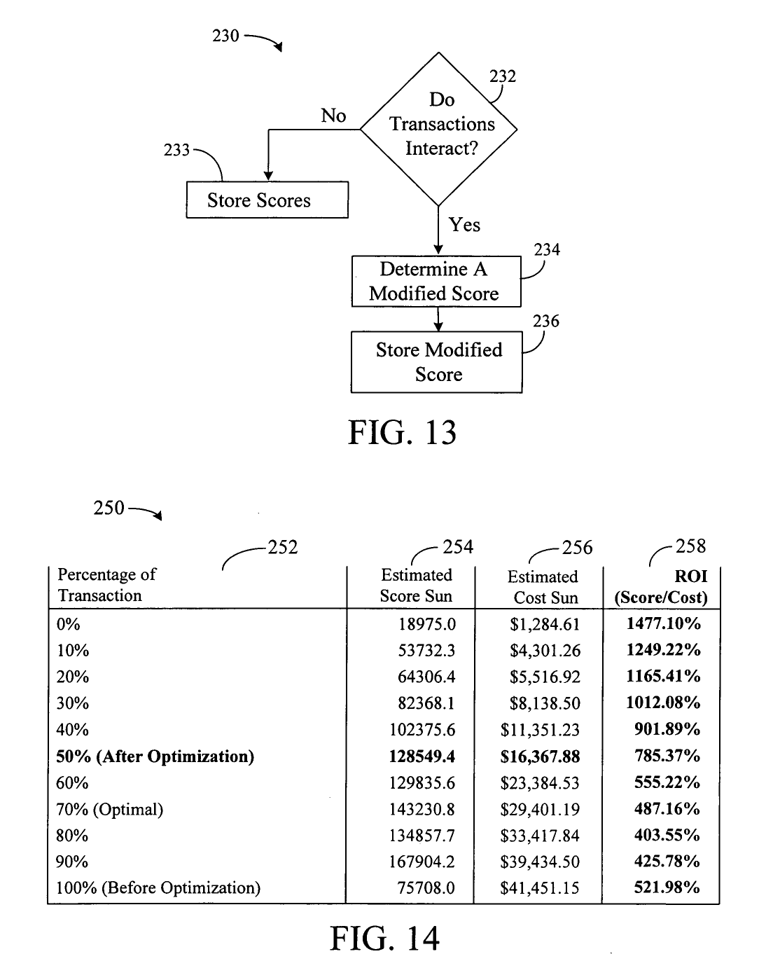

Referring to FIG. 13, the univariate scores with interactions approach uses a process 230 to modify the frequency distributions of scores. Process 230 determines (232) whether transactions do interact. For transactions that do not interact (i.e., executing the transaction would not prevent other transactions for a customer to occur), their scores would be stored (233) in the same way as in the univariate approach described above. For transactions that do interact, the process 230 determines (234) a modified score by taking the score of the transactions minus an opportunity cost, and additionally stores (236) the modified score for each transaction. So for example, if given two customers, customer 1, and customer 2, who may only receive a maximum of 1 offer each, and their scores for offers A and B were:

| | Offer A | Offer B |
|---|---|---|
| Customer 1 | 80 | 70 |
| Customer 2 | 50 | 30 |

Offer A's frequency distribution would receive an entry of 80−70=10 for customer 1, and an entry of 50−30=20 for customer 2. In this example, it is better to give offer A to customer 2 and offer B to customer for a total score of 50+70=120, than to give offer A to customer 1 and offer B to customer 2 for a total score of 80+30=110. Therefore, instead of settling for the best score for offer A, other offers (e.g., opportunity cost associated with giving the next best offer instead) are considered and evaluated before assigning offer A.

This example applies because B is not associated with a capacity constraint, otherwise neither offer A nor offer B might be assigned this transaction. In other examples, receiving an offer A would prevent a customer from getting both offer B and offer C. In this case, the scores of both offer B and offer C would be eliminated from the opportunity cost computation for offer A in the additional frequency distribution.

Other approaches of using frequency distributions in determining optimizations can be used. For example, an additional approach uses statistics in addition to help with modifying the scores. In this approach, starting with the univariate scores with interactions approach, statistics are kept and tracked for interactions between the capacity rules. For example, in cases where a customer could receive offer A or offer B, which both have capacity rules and interact with one another, the number of such cases are tracked, as well as the mean and variance of offer A's and offer B's scores and the covariance of offer a and offer B's scores. This approach provides a better estimate about how each frequency distribution's threshold may need to be modified. For example, if the scores for offer A and offer B are negatively correlated, there is less chance that offer A and offer B will be competing for the same customers, etc.

Another approach is a multivariate approach. In a multivariate approach, the frequency distributions are multidimensional. There could be as many dimensions as there are capacity or budget constraints. This approach keeps track of frequency distributions of combinations of offers, as opposed to single offers. While the added complexity in dealing with this extra detail would be expected to improve the optimality of the solutions found, it would also significantly increase the computation time, and is unlikely to be feasible using current computing technology.

Other approaches use Bayesian Updating of Rejection Probabilities. For example, Bayesian updating may be used to estimate rejection probabilities, and update frequency distribution thresholds accordingly. In the Bernoulli case, both the prior and posterior are beta distributions. The original prior beta distributions may be used as an optional user parameter. Then, if a rejection percentage is extreme, the prior beta distribution may be used from the start of the optimization.

Referring back to FIG. 10, optionally, further optimization may be performed in a third pass. For example, process 150 may sort (160) the transactions remaining after optimization. In other examples, the third pass may be added to optimize one constraint, so that one may choose to handle a budget in this manner and use frequency distributions in a single pass to do other offer/channel constraints.

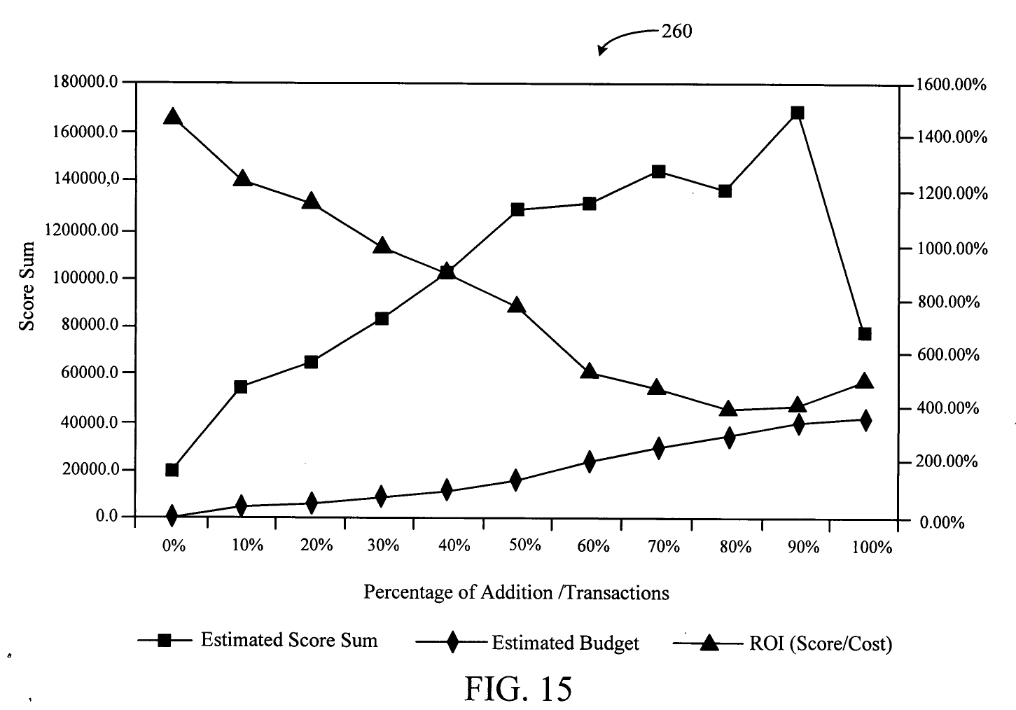

Referring to FIGS. 14 and 15, any of the processes previously described herein may be used in a sensitivity analysis to provide the user with a better understanding of the impact of certain decisions. Process 150 renders (162) analysis results to the user. For example, a sensitivity table 250 or a sensitivity graph 260 may be rendered on display 20.

Table 250 includes a “percentage of included transactions” column 252, an “estimated score sum” column 254, an “estimated cost sum” column 256 and a “return on investment (ROI)” column 258. Column 252 includes the percentage of additional transactions above a budget. Column 258 represents column 254 divided by column 256. Table 260 is a graphical representation of table 250.

Table 510 and graph 520 (FIG. 15) may be used by a user to make key management decisions about spending additional resources based on changes in parameters (e.g., transactions, budget, offers, capacity) to measure the sensitivity of these changes to other parameters. For example, if a customer had a fixed budget of $1 million, a sensitivity analysis would measure the impact of the optimization if the user included or excluded additional transactions.

In one example, a tool (not shown) may include a graphical user interface (GUI) (not shown) stored anywhere within system 10 to enable the user to change parameters. The tool may include tables, graphs and other visual aides to render a sensitivity analysis for the user to observe.

In other examples, the frequency distribution budget method does not include a fixed threshold, as would be the case when sorting, so that there may be some overlap between accepted and rejected transactions. To account for the overlap, the best-rejected transaction and the worst accepted transaction are tracked and their average is taken.

In other examples, the processes described herein may support multiple budgets such as, using a minimum budget or a maximum budget, and or any constraint in the numerator and denominator of the budget ratio in addition to profit, ROI and cost.

Using a more general minimum budget may be desirable to the user that has a “use it or lose it” budget. For example, a minimum budget may be generated by internally changing the cost for all offers so that all offers would all be profitable.

Another feature is having a minimum ROI by processing based on ROI, but also thresholding based on ROI rather than the cost.

A further feature minimizes or maximizes the total number of offers, using the following strategies:

(1) Sort by ROI, but the threshold is based on the number of offers rather than total cost.

(2) If the goal is not to maximize profit, but rather to maximize the number of offers sent, then giving the lowest cost offers the highest priority. This may be accomplished by setting the revenue=1 for all offers, and maximizing profit.

For example, the process can be viewed as a general solution and can be applied to other situations besides marketing involving customers and offers. In general, it could be applied to many other types of problems that are evaluated by linear programming techniques.

In one example, FIG. 10 may be modified to account for exactly one constraint. For example the process 150 may sort 154 or generate frequency distributions 156 depending on user preference.

The processes described herein are not limited to use with the hardware and software of FIG. 1; the processes may find applicability in any computing or processing environment and with any type of machine that is capable of running a computer program. The processes may be implemented in hardware, software, or a combination of the two. The processes may be implemented in computer programs executed on programmable computers/machines that each includes a processor, a storage medium/article readable by the processor (including volatile and non-volatile memory and/or storage elements), at least one input device, and one or more output devices. Program code may be applied to data entered using an input device to perform the processes and to generate output information.

Each such program may be implemented in a high-level procedural or object-oriented programming language to communicate with a computer system. However, the programs may be implemented in assembly or machine language. The language may be a compiled or an interpreted language. Each computer program may be stored on a storage medium (article) or device (e.g., CD-ROM, hard disk, or magnetic diskette) that is readable by a general or special purpose programmable computer for configuring and operating the computer when the storage medium or device is read by the computer to perform the processes. The processes may also be implemented as a machine-readable storage medium, configured with a computer program, where upon execution, instructions in the computer program cause the computer to operate in accordance with the processes.

The processes are not limited to the specific embodiments described herein. For example, the processes may be performed on the Internet or on a wide area network (WAN), a local area network (LAN) or on a stand-alone personal computer.

The processes are not limited to the specific processing order described in the figures. Rather, the processing order may be re-ordered, as necessary, to achieve the results set forth above.

1. A method for optimizing transactions to customers from a list of transactions, comprising:
generating a frequency distribution of scores for each offer based on at least one constraint;
determining a score threshold based on the frequency distribution of scores; and
adding or removing transactions from the list of transactions based on the score threshold.

2. The method of claim 1, wherein the at least one constraint is one of a budget constraint, an offer constraint and a capacity constraint.

3. The method of claim 1, further comprising:
generating a budget frequency distribution based on a budget ratio;
determining a budget threshold based on the budget frequency distribution; and
adding or removing transactions from the list of transactions based on the budget threshold.

4. The method of claim 1, wherein the budget ratio includes a cost and a score.

5. The method of claim 1, further comprising;
modifying the frequency distribution of scores based on interactions between transactions.

6. The method of claim 1, wherein the scores include a profitability value.

7. The method of claim 1, further comprising:
rendering a tool that includes a sensitivity analysis.

8. The method of claim 7, wherein the tool renders a graph.

9. The method of claim 7, wherein the tools renders a table.

10. The method of claim 7, wherein the tool includes a graphical user interface, the graphical user interface allows a user to change parameters to determine an impact on optimization.

11. An apparatus for optimizing transactions to customers from a list of transaction, comprising:
a memory that stores executable instructions; and
a processor that executes the instructions to:
generate a frequency distribution of scores for each offer based on at least one constraint;
determine a score threshold based on the frequency distribution of scores; and
add or remove transactions from the list of transactions based on the score threshold.

12. An article comprising a machine-readable medium that stores executable instructions for optimizing transactions to customers from a list of transaction, the instructions causing a machine to:
generate a frequency distribution of scores for each offer based on at least one constraint;
determine a score threshold based on the frequency distribution of scores; and
add or remove transactions from the list of transactions based on the score threshold.
